(19) United States
(12) Patent Application Publication
(10) Pub. No.: US 2015/0371126 A1
(43) Pub. Date: Dec. 24, 2015

(54) IMAGE FORMING APPARATUS AND METHOD

(71) Applicant: FUJI XEROX CO., LTD., Tokyo (JP)

(72) Inventor: Mitsuhiko OTA, Kanagawa (JP)

(21) Appl. No.: 14/532,291

(22) Filed: Nov. 4, 2014

(30) Foreign Application Priority Data
Jun. 19, 2014 (JP) 2014-125917

(51) Int. Cl. G06K 15/00; G06K 15/02

(52) U.S. Cl. CPC G06K 15/408; G06K 15/1806

(57) ABSTRACT

An image forming apparatus includes an image forming unit, a detector, an avoidance process memory, a print data memory, and an acceptor. The image forming unit receives a print instruction including print data and a print setting and forms an image on a sheet. The detector analyzes the print data and/or the print setting in the print instruction, and detects an error that is an unprocessable or invalid instruction. The avoidance process memory stores an error avoidance process of avoiding the error and enabling execution of image formation, in association with the print instruction including the error. The print data memory stores the print data in the print instruction including the error. The acceptor accepts an instruction to avoid the error and to execute image formation, in accordance with the stored error avoidance process and the stored print data.

### CROSS-REFERENCE TO RELATED APPLICATIONS

This application is based on and claims priority under 35 USC 119 from Japanese Patent Application No. 2014-125917 filed Jun. 19, 2014.

### BACKGROUND

### Technical Field

The present invention relates to an image forming apparatus and an image forming method.

### SUMMARY

According to an aspect of the invention, there is provided an image forming apparatus including an image forming unit, a detector, an avoidance process memory, a print data memory, and an acceptor. The image forming unit receives a print instruction including print data and a print setting and forms an image on a sheet. The detector analyzes at least one of the print data and the print setting in the print instruction received by the image forming unit, and detects an error that is an instruction unprocessable by the image forming apparatus or an instruction invalid for the image forming apparatus to process. The avoidance process memory stores, in a case where the error is detected by the detector, an error avoidance process of avoiding the error and enabling execution of image formation, in association with the print instruction including the error. The print data memory stores, in a case where the error is detected by the detector, the print data in the print instruction including the error. The acceptor accepts an instruction to avoid the error and to execute image formation, in accordance with the error avoidance process stored in the avoidance process memory and the print data stored in the print data memory.

### BRIEF DESCRIPTION OF THE DRAWINGS

Exemplary embodiments of the present invention will be described in detail based on the following figures, wherein:

FIG. 1 is a diagram illustrating an exemplary configuration of an image forming system to which an exemplary embodiment is applied;

FIG. 2 is a diagram illustrating an exemplary configuration of an image forming apparatus to which the exemplary embodiment is applied;

FIGS. 3A and 3B are diagrams illustrating exemplary screens displayed on a user interface (UI) of the image forming apparatus;

FIG. 3C is a diagram illustrating an exemplary reprint screen displayed on the UI of the image forming apparatus;

FIGS. 4A to 4C are diagrams illustrating differences in print results, which are caused by selection of an error avoidance method;

FIG. 5A is a flowchart illustrating an exemplary print operation of the image forming apparatus;

FIG. 5B is a flowchart illustrating the exemplary print operation of the image forming apparatus; and

FIG. 6 is a diagram illustrating another exemplary reprint screen according to a modification.

### DETAILED DESCRIPTION

Hereinafter, an exemplary embodiment of the present invention will be described in detail with reference to the accompanying drawings.

### Image Forming System 1

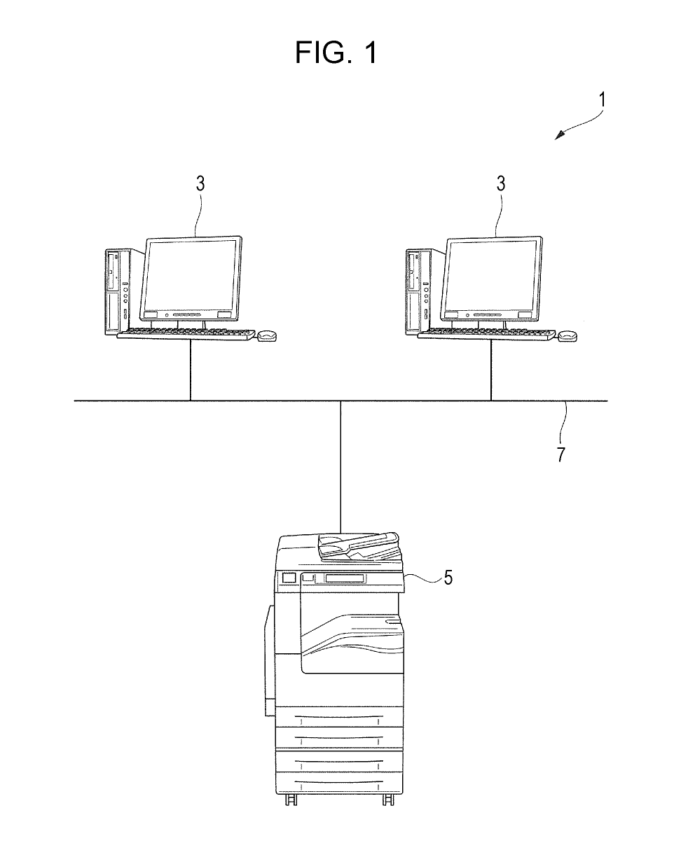

FIG. 1 is a diagram illustrating an exemplary configuration of an image forming system 1 to which the exemplary embodiment is applied.

As illustrated in FIG. 1, the image forming system 1 is configured by connecting a terminal apparatus 3 and an image forming apparatus 5 via a network 7.

The terminal apparatus 3 is a computer apparatus that gives a print instruction to the image forming apparatus 5. Here, a personal computer (PC), for example, may be used as the terminal apparatus 3. In this case, the PC may be one that operates as a client PC or one that operates as a server PC. Alternatively, the terminal apparatus 3 may be, for example, a tablet terminal or a mobile terminal. In the illustrated example, two (multiple) terminal apparatuses 3 are connected to the image forming apparatus 5. However, for example, one terminal apparatus 3 or three or more terminal apparatuses 3 may be connected to the image forming apparatus 5.

The image forming apparatus 5 has an image forming function (print function) of forming an image on a medium such as a sheet. For example, a so-called multifunctional apparatus that has an image reading function of reading an image from a medium such as a sheet and a facsimile function, besides an image forming function, may be used as the image forming apparatus 5.

The network 7 is a communication line network used for communicating information between each terminal apparatus 3 and the image forming apparatus 5. Here, for example, a local area network (LAN), the Internet, wireless communication, or short range wireless communication may be used as the network 7.

### Image Forming Apparatus 5

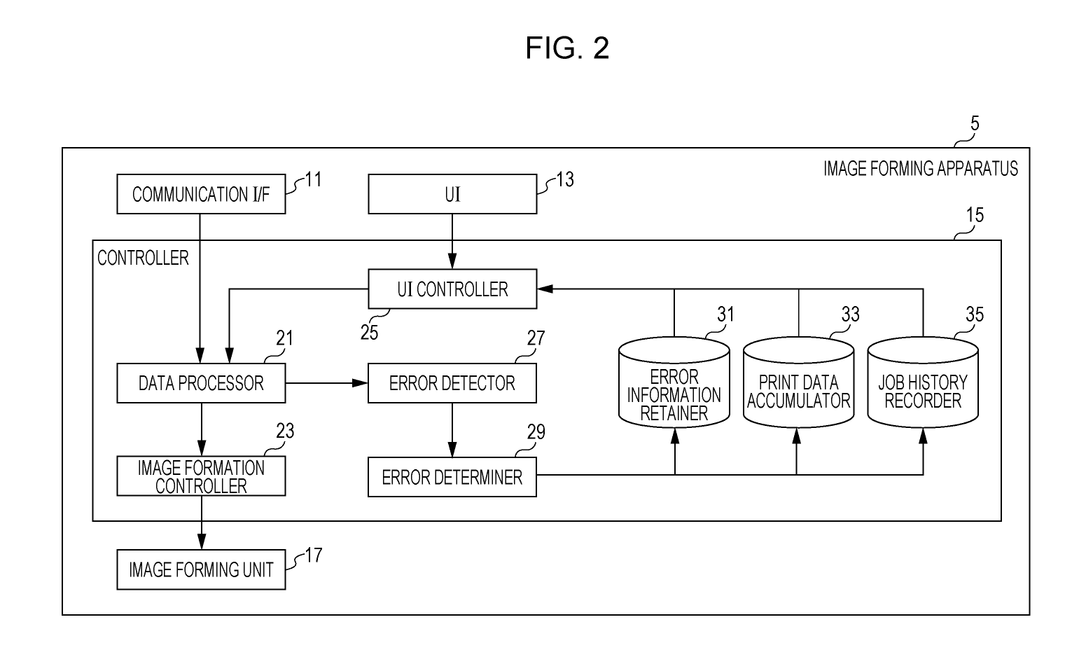

FIG. 2 is a diagram illustrating an exemplary configuration of the image forming apparatus 5 to which the exemplary embodiment is applied.

Next, the configuration of the image forming apparatus 5 will be described with reference to FIG. 2.

As illustrated in FIG. 2, the image forming apparatus 5 includes a communication interface (I/F) 11, a user interface (UI) 13, a controller 15 (described later), and an image forming unit 17.

The communication I/F 11 performs communication with the outside. Specifically, the communication I/F 11 receives a print instruction from the terminal apparatus 3 via the network 7.

Here, the term “print instruction” refers to an instruction that causes the image forming apparatus 5 to execute printing and includes print data and print settings, in addition to a print execution command.

Print data is, for example, page description language (PDL) data written in PDL and includes an image quality instruction that is an instruction regarding image quality, such as resolution, gradation information, and screen, and a render command that is a command for rendering a character, a figure, an image, or the like.

Print settings are settings for performing printing on a sheet in accordance with print data and include, for example, specification of image quality, such as high image quality or normal image quality, specification of a color mode such as multicolor or monochrome, specification of a duplex mode for performing duplex printing, specification of an N-up mode for forming multiple (N) images on one sheet, and specification of a booklet mode for printing a booklet.

The UI 13 includes a display panel, and the UI 13 accepts an instruction from a user and displays a message or the like for the user. The UI 13 accepts a reprint instruction on the basis of a user operation, though details of which will be described later. Note that the UI 13 is an example of an acceptor and a formed image display.

The image forming unit 17 forms (prints) an image on a sheet. Note that, for example, one that executes an electrophotographic process or one that executes an inkjet process may be used as the image forming unit 17.

Note that the image forming apparatus 5 may include, besides the units illustrated in the drawing, for example, a post-processor (not illustrated) for executing so-called post processing such as punching or binding sheets on which images are formed, an image reading unit (not illustrated) for reading an image from a medium such as a sheet, or a facsimile function unit (not illustrated).

Next, the controller 15 included in the image forming apparatus 5 will be described.

The image forming apparatus 5 includes, as the functions of the controller 15, a data processor 21, an image formation controller 23, a UI controller 25, an error detector 27, an error determiner 29, an error information retainer 31, a print data accumulator 33, and a job history recorder 35.

Here, note that the data processor 21 and the error detector 27 are examples of a detector. The data processor 21 is an example of a replacing unit. The error detector 27 is an example of a determiner. The error information retainer 31 is an example of an avoidance process memory. The print data accumulator 33 is an example of a print data memory.

The data processor 21 processes a print instruction received by the communication I/F 11. Specifically, the data processor 21 analyzes at least one of print data and print settings in the print instruction. More specifically, the data processor 21 analyzes, for example, print data (an electronic document file in PDL or Portable Document Format (PDF)/Extensible Markup Language (XML) Paper Specification (XPS)) in the print instruction, and performs rasterizing in accordance with the analysis result. Then, the data processor 21 outputs the print instruction including the rasterized print data to the image formation controller 23. In addition, the data processor 21 performs processing to exclude a page where an error has occurred or to replace a page where an error has occurred with another logical page in the print instruction, though details of which will be described later.

The image formation controller 23 controls the operation of the image forming unit 17. Specifically, the image formation controller 23 receives a print instruction including rasterized print data and print settings from the data processor 21, and controls the image forming unit 17 to form an image in accordance with the print instruction.

The UI controller 25 controls the operation of the UI 13. Specifically, the UI controller 25 controls the UI 13 to display job status screens 50 and 60 (described later) and a reprint screen 70 (described later) in accordance with information stored in the error information retainer 31, the print data accumulator 33, and the job history recorder 35, and to accept user instructions based on these screens.

The error detector 27 detects an error in a print instruction and a reprint instruction. Here, the term “error” refers to an instruction unprocessable by the image forming apparatus 5 or an instruction inappropriate (invalid) for the image forming apparatus 5 to process. The expression “an instruction unprocessable by the image forming apparatus 5” refers to a print instruction that the image forming apparatus 5 is incapable of executing, though the print instruction itself has no problem. Examples of such instructions unprocessable by the image forming apparatus 5 include a duplex printing instruction though the image forming apparatus 5 has no duplex function, a print instruction that specifies a sheet size of A3 though the image forming apparatus 5 is an A4 machine, a print instruction that specifies color printing though the image forming apparatus 5 is a monochrome machine, a print instruction that includes an image process exceeding the memory capacity of the image forming apparatus 5, and a print instruction that specifies font data that the image forming apparatus 5 does not have. In addition, the expression “an instruction invalid for the image forming apparatus 5 to process” refers to a print instruction that has a problem. Examples of such instructions include a print instruction in which an attribute that accompanies a command in the print instruction is invalid, and a print instruction that lacks such an attribute.

The error determiner 29 determines an error detected by the error detector 27. Specifically, the error determiner 29 stores in advance category (type) information of errors classified into “critical”, “ignorable and continuance OK”, and “replacement process OK”, for example. Referring to the stored category information, the error determiner 29 determines to which of the categories an error detected by the error detector 27 belongs.

Here, the category “critical” refers to a category to which an error that involves sudden stop of printing belongs. For example, the case in which an error is caused by processing of information regarding the overall print data belongs to the category “critical”. More specifically, for example, the case in which determination of PDL is not possible, and the case in which data describing the structure of the overall print data is defective belong to the category “critical”.

In addition, the category “ignorable and continuance OK” refers to a category to which the following error belongs: an error in which, by ignoring (skipping) a corresponding print instruction without processing it, a subsequent render command in that print command is processable. For example, the case in which there is an error only in a single render command, and the case in which an error is caused by flaws in resources to which a render command refers belong to the category “ignorable and continuance OK”. In addition, the case in which there is no specified font data, the case of an unknown (unsupported) render command, and the case in which image data is defective belong to the category “ignorable and continuance OK”. In addition, for example, the case in which it is confirmed that print data has been altered, by information (such as signature data or Message Digest Algorithm 5 (MD5) checksum) given to the print data and used for confirming that the print data is not altered, belongs to the category “ignorable and continuance OK”.

In addition, the category “replacement process OK” refers to a category to which the following error belongs: an error that is processable by changing a corresponding print instruction to other settings. Specifically, for example, the case in which a corresponding sheet size is unfeedable and another sheet size may be selected, the case in which post-processing is unexecutable at a specified position and another position may be selected, the case in which an unprintable color mode is specified (for example, multicolor is specified though only monochrome printing is possible) and the color mode may be forcedly changed (such as setting to monochrome), the case in which there is no specified font data and a replacing font may be selected, and the case in which print data is encrypted by password or the like and the password may be input belong to the category “replacement process OK”.

Note that, in the case where the error determiner 29 determines that an error has occurred, the error determiner 29 stores that print instruction and an error occurrence flag that has been turned ON in association with each other in a memory (not illustrated).

The error information retainer 31 stores in advance the types of errors that occur or may occur in the image forming apparatus 5 and a method for avoiding each of these errors (error avoidance methods, error avoidance processes).

Here, examples of error avoidance methods include exclusion of a page where an error has occurred, changing of a print setting such as the image quality mode or the color mode, and changing to another instruction method such as changing to another format, though details of which will be described later.

Note that, for example, for each error, one error avoidance method is stored, or two or more (multiple) error avoidance methods are stored.

In addition, the error information retainer 31 stores information regarding an error determined by the error determiner 29. Specifically, the error determiner 29 stores on which page of a print instruction or a reprint instruction an error has occurred (error occurrence page), and from which terminal apparatus 3 or which user a command of the print instruction or the reprint instruction has been output (error occurrence command location). At this time, the error occurrence page and the error occurrence command location are stored in association (linked) with the occurred error and that error's error avoidance method. Here, the term “association” refers to a status in which, for example, when reading stored information, an item of information among multiple items of information that are stored in association with each other is identifiable by identifying another item among the multiple items of associated information.

The print data accumulator 33 stores a print instruction determined by the error determiner 29 to include an error. More specifically, the print data accumulator 33 stores a print instruction in the case where it is determined by the error determiner 29 that an error that has occurred belongs to the category “ignorable and continuance OK” or the category “replacement process OK”.

Note that the pint instruction stored here is a print instruction, which is received by the communication I/F 11, after being processed by the data processor 21, and specifically is print data that has been analyzed and rasterized. More specifically, the print instruction stored in the print data accumulator 33 is usable in image formation (reprinting) by the image forming unit 17 via the image formation controller 23 without being processed by the data processor 21.

The job history recorder 35 stores the history of a job regarding a print instruction received by the image forming apparatus 5 (a series of image forming operations performed in accordance with the print instruction) along with a status in which the job has been completed, that is, the job result. Specifically, for a job that has been completed (ended) without any errors, the job history recorder 35 stores that job's job result as completed. In addition, for a job that has been ended before being completed since an error has occurred, the job history recorder 35 stores that job's job result as completed with error.

Though not illustrated in the drawings, the controller 15 includes a central processing unit (CPU) serving as an arithmetic operation unit, and a main memory and a magnetic disk drive (hard disk drive (HDD)) serving as a memory. Here, the CPU executes various types of software such as an operating system (OS) and an application and realizes the above-mentioned functions. In addition, the main memory is a storage area that stores various types of software and data used in execution thereof. In addition, the magnetic disk drive is a storage area that stores input data for the various types of software and output data from the various types of software.

### Reprinting

In the related art different from the exemplary embodiment, in the case where an error occurs during analysis or rasterizing of print data, an output is terminated at that point, and a corresponding job is completed as completion with error.

In addition, in order to avoid the error which has occurred, in many cases a user may exclude a page where the error has occurred on the terminal apparatus 3 side, change print settings, or specify another instruction method (change to another format or use a printer driver on the terminal apparatus 3 side) to perform reprinting and thus obtain an output result. Further, in the case where the location of the occurrence of the error (the page where the error has occurred or the position in that page) or the cause of the occurrence of the error is unknown, it not only involves efforts since the correct error avoidance method is not selectable, but also a user who comes to the image forming apparatus 5 in order to obtain an output result may be asked to return from the image forming apparatus 5 to the terminal apparatus 3 with which the user has given the print instruction.

More specifically, for example, in the case where an electronic document file is to be directly processed by the image forming apparatus 5, if the electronic document file includes a print instruction that does not conform to the specification of the image forming apparatus 5, in many cases, an error occurs as a result of the details of the electronic document file, leading to completion with error. In contrast, even when the process is continued while ignoring a portion where such an error has occurred, in many cases, the output result becomes one that the user desires. There are many advantages in obtaining a print result even by performing some sort of error avoidance method.

In the exemplary embodiment, reprinting is executed by the image forming apparatus 5.

Note that the term “reprint” refers to execution of printing again on the basis of a print instruction retained (stored) by the image forming apparatus 5 for an ended job. At this time, the print instruction retained by the image forming apparatus 5 is, for example, received print data that has been analyzed and rasterized. In addition, the print instruction retained by the image forming apparatus 5 is such that at least part of the settings of the print instruction is changeable (rewritable) to other settings.

Now, an overview of execution of reprinting in the exemplary embodiment will be described.

First, in the exemplary embodiment, in the case where the error detector 27 detects an error, the type of the error and the location of the occurrence thereof (page position where the error has occurred, and the terminal apparatus 3 or user who has output the print instruction) are associated (linked) with the print data and are accumulated. In addition, at the time the error has been detected, an output of the print instruction to the image forming unit 17 is stopped, though analysis and rasterizing of the print data are continued. When processing of the print data ends, another error that occurs in the same print instruction is collectively stored as error information, and as in existing completion with error, the print job is switched to the next print job. Accordingly, a job of a print instruction where an error has been detected is ended once, and hence there will be no influence on execution of a subsequent job. More specifically, the print result of a subsequent job may be output prior to the print result of a job of a print instruction where an error has been detected. This reduces the risk of other users waiting for execution of a job, such as in the case in which multiple users share and use the image forming apparatus 5.

The accumulated print data and error information are displayed as job status screens 50 and 60 (described later) on the UI 13 of the image forming apparatus 5. Accordingly, a corresponding job that has been completed with error is reported to the user. In addition, a reprint button 67 (described later) that accepts an instruction for reprinting a job that has ended with error is displayed on the UI 13, and hence the user is able to give a reprint instruction while operating (pressing) the reprint button 67. In addition, regarding a reprint instruction, choices for avoiding an error are displayed on the basis of accumulated error information. Thus, the user is able to give a reprint instruction in accordance with the choices.

Hereinafter, screens displayed on the UI 13 of the image forming apparatus 5, that is, the job status screens 50 and 60 and the reprint screen 70, will be described. Thereafter, error avoidance methods displayed as the choices on the reprint screen 70 will be described. Thereafter, a print operation, including reprinting, of the image forming apparatus 5 will be described.

### UI Screen

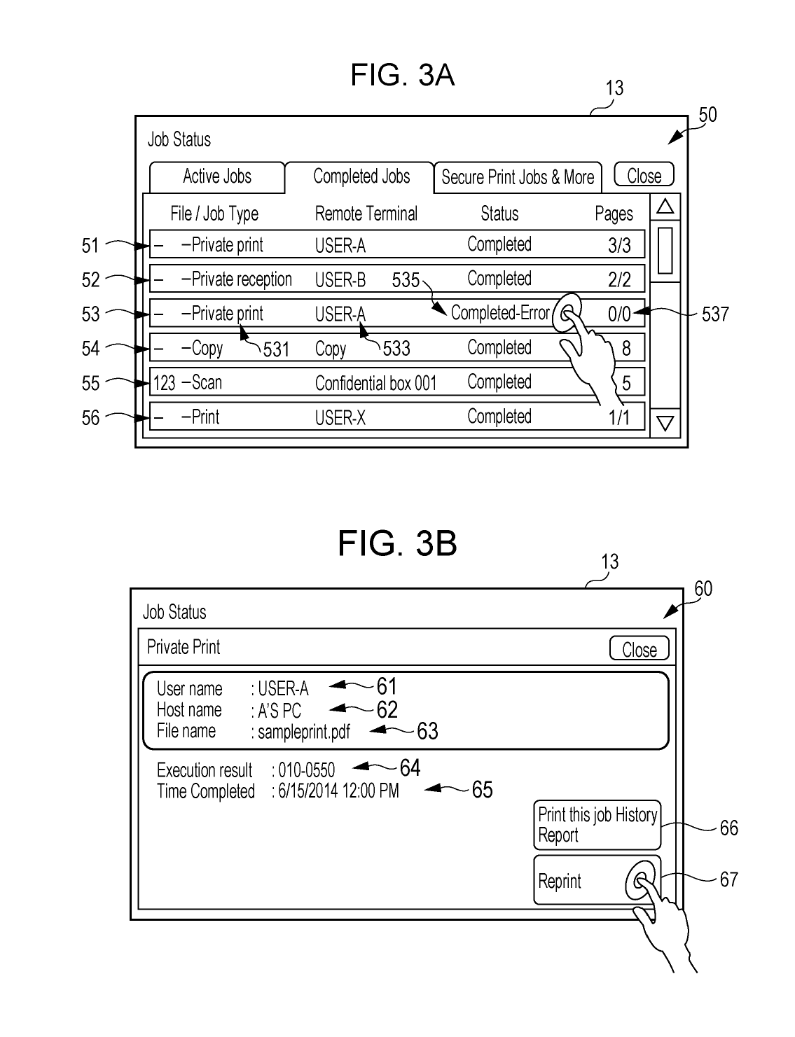

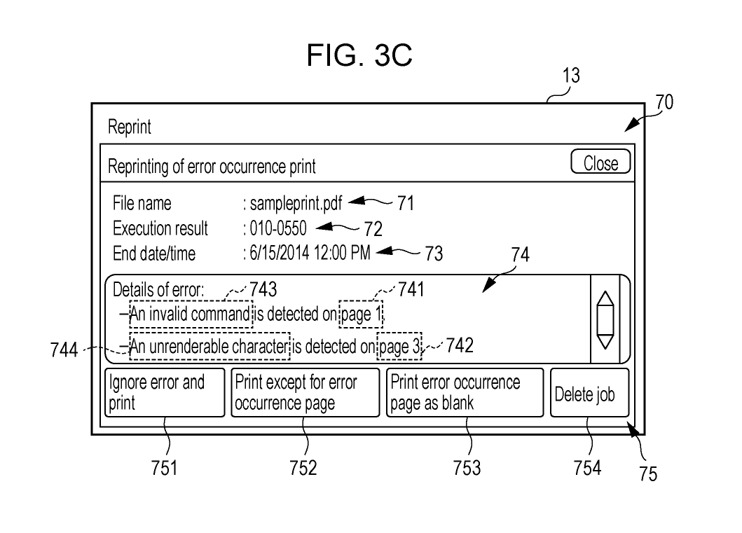

FIGS. 3A, 3B, and 3C are diagrams illustrating exemplary screens displayed on the UI 13 of the image forming apparatus 5. Specifically, FIGS. 3A and 3B illustrate examples of the job status screens 50 and 60 displayed on the UI 13 of the image forming apparatus 5, and FIG. 3C illustrates an example of the reprint screen 70 displayed on the UI 13 of the image forming apparatus 5. Note that the job status screens 50 and 60 and the reprint screen 70 are displayed on the UI 13 by the UI controller 25 on the basis of information regarding jobs stored in the error information retainer 31 and the job history recorder 35, in response to a user operation of the UI 13, for example.

As illustrated in FIG. 3A, the job status screen 50 is a screen indicating a list of executed jobs, that is, a history of jobs. Note that the job status screen 50 is an example of a history display.

With the job status screen 50, the user is able to understand the completion status of each job. Here, the job status screen 50 includes job information displays 51 to 56 indicating information of jobs that have been completely executed.

Here, the job information display 53 will be described by way of example. The job information display 53 includes job identification information 531 such as the number of a document (document number) that executes that job, user related information 533 such as a user who has given a print instruction or the details of that job, completion status information 535 regarding the completion status of that job, and page information 537 regarding the number of pages printed by that print instruction. Here, in the illustrated example, “private print” is displayed as the job identification information 531; “USER-A” is displayed as the user related information 533; “completed-error” indicating a job that has been ended since an error has occurred is displayed as the completion status information 535; and “0/0” indicating that there is no printed sheet is displayed as the page information 537.

When the user selects one of the job information displays 51 to 56 by touching on the UI 13 screen, for example, the screen is switched to another screen, namely, the job status screen 60 (FIG. 3B). The job status screen 60 displays more detailed information regarding each of the jobs than a corresponding one of the job information displays 51 to 56 does.

Here, the job status screen 60 in the case where the job information display 53 which is a display regarding a job that has been ended since an error has occurred is selected will be described.

As illustrated in FIG. 3B, the job status screen 60 includes user information 61 indicating a user who has given the print instruction, terminal information 62 indicating a terminal apparatus 3 that has given the print instruction, file information 63 indicating the file name of the document, execution result information 64 indicating the result of executing the job, and time information 65 regarding a date and time at which the job has been completed. In addition, the job status screen 60 includes, for example, a report output button 66 that accepts an instruction to print information displayed on the job status screen 60 on a sheet, that is, to perform a job history report output, and the reprint button 67 which accepts an instruction to reprint an ended job. A report output by the report output button 66 is used in, for example, the case where a user gives a print instruction again.

When the user selects the reprint button 67 by touching on the UI 13 screen, for example, the screen is switched to the reprint screen 70 for an ended job (see FIG. 3C).

The reprint screen 70 includes, as illustrated in FIG. 3C, file information 71 indicating the file name, execution result information 72 indicating the result of executing the job, and time information 73 regarding a date and time at which the job has been completed. In addition, the reprint screen 70 includes error information 74 regarding an error that has occurred in the print instruction, and a process determination button 75 that triggers determination of a process for the print instruction in which an error has occurred and execution of reprinting.

Note that the file information 71 is an example of an error display, and the process determination button 75 is an example of a process display and an instruction acceptor.

Here, the error information 74 includes error page information 741 and 742 each indicating an error occurrence page, and error type information 743 and 744 each indicating the type of the occurred error.

In addition, the process determination button 75 includes information regarding an error avoidance method. In addition, in the illustrated example, the process determination button 75 includes multiple buttons for determining execution of a process in accordance with various different error avoidance methods. In the example, the process determination button 75 includes a first button 751, a second button 752, a third button 753, and a fourth button 754.

The first button 751 accepts an instruction to perform “ignore error and print” that ignores the occurred error without processing the error, and that executes (prints) the job. The second button 752 accepts an instruction to perform “print except for an error occurrence page” that executes the job except for a page where an error has occurred. The third button 753 accepts an instruction to perform “print an error occurrence page as blank” that executes the job while printing a page where an error has occurred as blank, that is, that replaces a page where an error has occurred with a logical page and performs printing. The fourth button 754 accepts an instruction to perform “delete job” that cancels a print instruction (job) where an error has occurred without reprinting the job.

When the user selects one of the first button 751 to the fourth button 754 by touching on the UI 13 screen, for example, a reprint instruction is given while specifying an error avoidance method.

### Error Avoidance Method

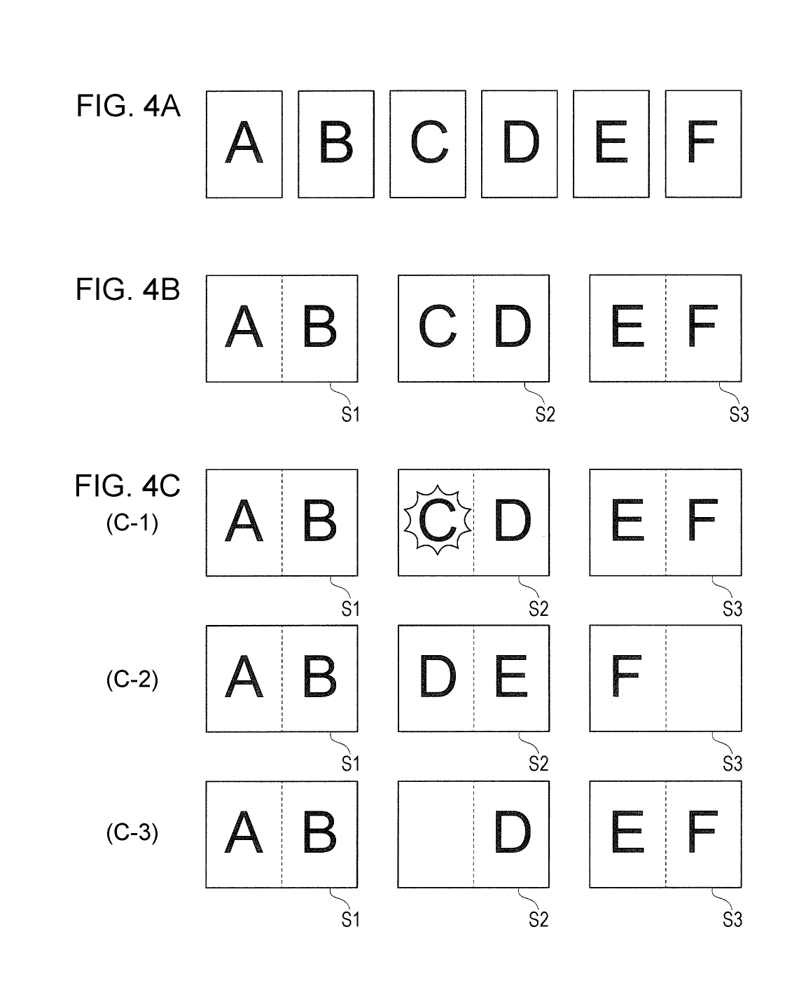

FIGS. 4A to 4C are diagrams describing differences in print results, which are caused by selection of an error avoidance method. Specifically, FIG. 4A is a diagram describing a print instruction. FIG. 4B is a diagram describing a normally completed print result. FIG. 4C includes diagrams describing reprinted print results.

Next, with reference to FIG. 3C and FIGS. 4A to 4C, an error avoidance method set on the reprint screen 70 will be described in detail.

As described above, an error avoidance method is specified by selecting any of the first button 751 to the fourth button 754. In accordance with the selected error avoidance method, the form of a reprinted print result may change.

Note that a print instruction to print six images A to F, such as those illustrated in FIG. 4A, in this order in N-up mode (2-UP that forms two images on one sheet) will be described here. In addition, it is assumed that the print instruction includes an error in a print instruction for the image C.

First, as illustrated in FIG. 4B, when the job is normally completed in accordance with the print instruction, the images A and B are formed on a sheet S1, the images C and D are formed on a sheet S2, and the images E and F are formed on a sheet S3.

In contrast, as illustrated in FIG. 4C, the reprinted print result has a different form from that of the print result in the case of a completed job (see FIG. 4B). In addition, the reprinted print result changes depending on the error avoidance method. More specifically, the layout of the overall print result (page imposition) changes depending on the error avoidance method.

Specifically, in the case where the first button 751 is selected, that is, “ignore error and print” is selected, the print result becomes one illustrated in part (C-1) of FIG. 4C. Specifically, among the formed images A to F, the image C includes an error in its print instruction, and hence the image C is formed differently from an image that is to be intrinsically formed (see the image C formed on the sheet S2 in FIG. 4B). At this time, the positions of the images A to F formed on the sheets S1 to S3 match the positions of the images A to F in FIG. 4B.

The first button 751 is selected in the case where, for example, even when an error occurrence page in the print result may be different from what is desired (a WYSIWYG problem occurs), that problem is tolerable for the user. In addition, even in the case where printing is performed while ignoring the error, the result may not be different from a separately displayed application. Thus, the first button 751 is also selected in the case where the user wants to obtain a print result for the time being, for example.

Next, in the case where the second button 752 is selected, that is, “print except for an error occurrence page” is specified, the print result becomes one illustrated in part (C-2) of FIG. 4C. Specifically, printing is performed except for the image C including an error. Accordingly, the image D is formed after the image B, and the positions of the images D, E, and F (images subsequent to the image C) formed on the sheets S2 and S3 in part (C-2) of FIG. 4C are different from the positions of the images D, E, and F formed on the sheets S2 and S3 in FIG. 4B. That is, in the case where the second button 752 is selected, the layout of the overall print result changes. The second button 752 is selected in the case where, unlike the illustrated example, for example, an error occurrence page is to be printed again in a print instruction in which the layout of the overall print result does not change.

Next, in the case where the third button 753 is selected, that is, “print an error occurrence page as blank” is specified, the print result becomes one illustrated in part (C-3) of FIG. 4C. Specifically, a portion where the image C including an error is to be formed is formed as blank. At this time, the positions of the images A, B, D, E, and F formed on the sheets S1 to S3 match the positions of the images A, B, D, E, and F formed on the sheets S1 to S3 in FIG. 4B. Since the third button 753 involves no change in pages including no error, other than an error occurrence page, from the case of a normal output, these pages are easy to reuse when replacing a print result.

Note that, in the case where the fourth button 754 is selected, that is, “delete job” is specified, printing is not executed, and the job ends without obtaining a print result. The fourth button 754 is selected in the case where, for example, the user wants to give a print instruction again from the terminal apparatus 3.

As described above, in the case where N-up mode is specified, the layout of the overall print result may change when “print (is performed) except for an error occurrence page”.

Note that the fact that the layout of the overall print result may change is not limited to the case in which N-up mode is specified; the layout of the overall print result may change when “print (is performed) except for an error occurrence page” in the case where duplex mode is specified or booklet mode is specified.

In contrast, the user may want the layout not to change, that is, the user may want to select an error avoidance method other than “print except for an error occurrence page” as an error avoidance method. To this end, the data processor 21 may determine whether a print instruction to be processed is a print instruction where the layout of the overall print result may change. Note that the configuration may be one that outputs a blank page only in the case where a page subsequent to an error occurrence page (a page to be excluded) is to be printed.

In addition, in the case where it is determined that a print instruction to be processed is a print instruction where the layout of the overall print result may change, the UI controller 25 may restrict the second button 752, which specifies “print except for an error occurrence page”, from being selected on the reprint screen 70. Note that the fact that the second button 752 is restricted from being selected refers to an example in which selection of the second button 752 is not to be accepted, or the second button 752 is not displayed.

Here, as illustrated in FIG. 4C, even in the case where print data in which an error occurs by executing reprinting is sent to the image forming apparatus 5, a rendered portion where no error occurs and a page including no error are output as a print result. In addition, in the case where a blank page where nothing is printed is formed in a reprinted print result, or in the case where there is a skipped page, the user is able to detect a portion where an error has occurred and to avoid the error (such as by replacing a skipped portion with another rendering).

### Print Operation

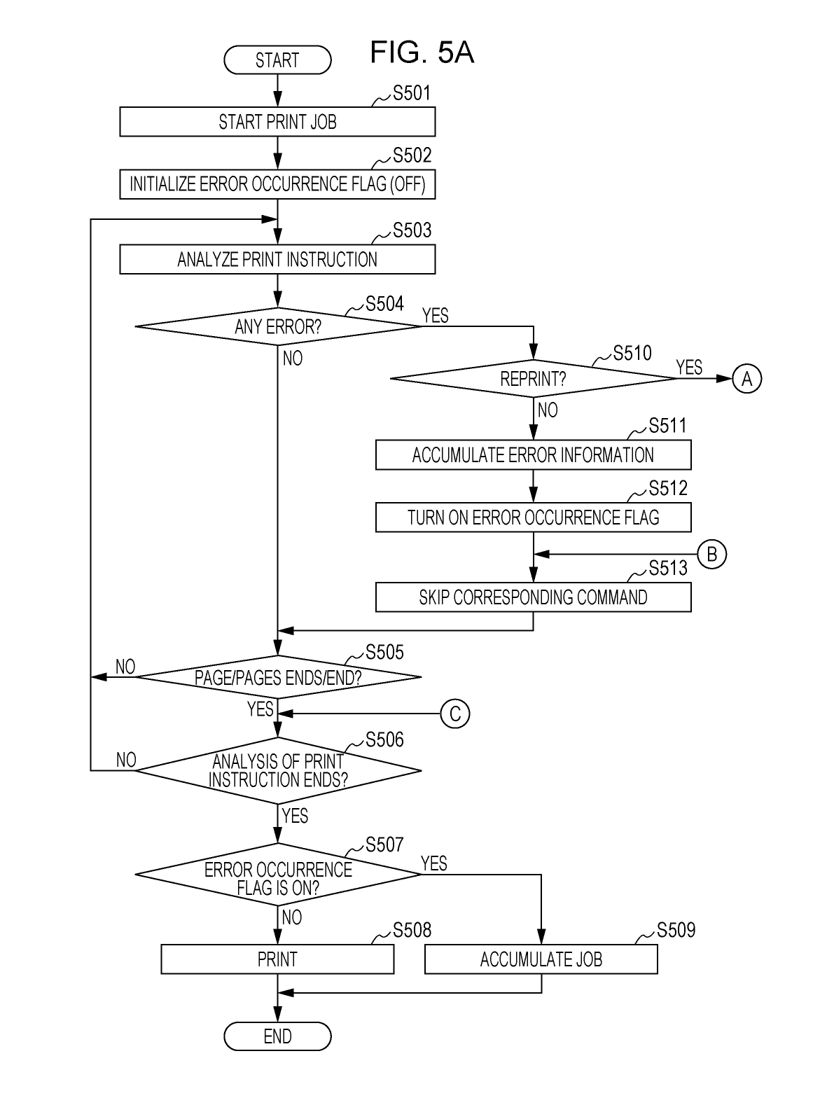

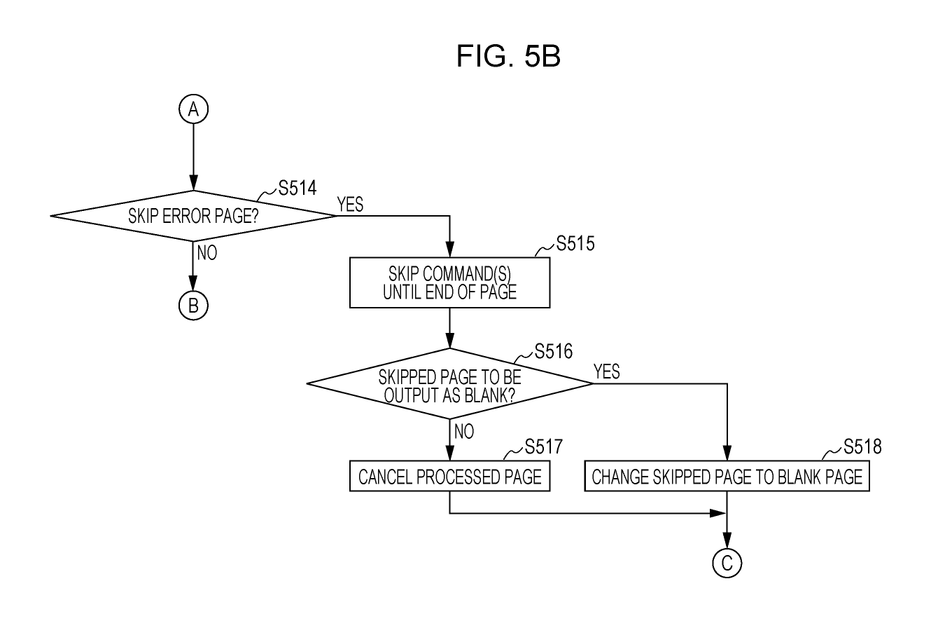

FIGS. 5A and 5B are flowcharts illustrating an exemplary print operation of the image forming apparatus 5.

Next, with reference to FIGS. 1, 2, 5A, and 5B, the print operation of the image forming apparatus 5 will be described. Here, after the print operation in response to reception of a print instruction from the terminal apparatus 3 (print operation that is not reprinting, normal print operation) is described, the print operation in response to a reprint instruction received by the image forming apparatus 5 (reprint operation) will be described.

First, the normal print operation in response to reception of a print instruction from the terminal apparatus 3 will be described.

In response to reception by the communication I/F 11 of a print instruction from the terminal apparatus 3, a print job is started (step S501). As the print job is started, the error determiner 29 initializes an error occurrence flag. That is, the error determiner 29 turns “OFF” the error occurrence flag (step S502).

The data processor 21 analyzes the print instruction (step S503). In addition, the error detector 27 determines whether an error has been detected (step S504).

Here, the case in which no error is detected in the entire print instruction in the normal print operation will be described.

That is, in the case where the error detector 27 detects no error (No in step S504), the data processor 21 determines whether a page or pages to be analyzed ends/end (step S505). In the case where a page or pages to be analyzed does/do not end (No in step S505), the data processor 21 continues analyzing (step S503). In contrast, in the case where a page or pages to be analyzed ends/end (Yes in step S505), the data processor 21 determines whether the entire print instruction has been analyzed (step S506). In the case where the entire print instruction has not been analyzed (No in step S506), the data processor 21 continues analyzing (step S503). In contrast, in the case where the entire print instruction has been analyzed (Yes in step S506), the image formation controller 23 determines whether the error occurrence flag is “ON” (step S507). Here, since the status is one in which no error has been detected in the entire print instruction, that is, the error occurrence flag remains to be initialized as the “OFF” status, the image forming unit 17 forms an image on a sheet (step S508). Note that the job for this print instruction enters a normally completed status.

Next, the case in which an error is detected in the print instruction in the normal print operation will be described.

That is, in the case where the error detector 27 detects an error (Yes in step S504), the data processor 21 determines whether the print instruction is a reprint instruction (step S510). In the case where the print instruction is not a reprint instruction (No in step S510), the error information retainer 31 stores error information of the detected error (step S511). In addition, the error determiner 29 turns “ON” the error occurrence flag (step S512). The data processor 21 ignores (skips) a render command where the error has occurred, and continues analyzing (step S513).

Next, the data processor 21 determines whether a page or pages to be analyzed ends/end (step S505), and, in the case where a page or pages to be analyzed ends/end (Yes in step S505), the data processor 21 determines whether the entire print instruction has been analyzed (step S506). In the case where the entire print instruction has been analyzed (Yes in step S506), the image formation controller 23 determines whether the error occurrence flag is “ON” (step S507). Here, since the error occurrence flag remains to be in the “ON” status since step S512 (Yes in step S507), the print data accumulator 33 and the job history recorder 35 each store (accumulate) information regarding the print instruction (job) where the error has occurred (step S509). Note that the job for this print instruction enters a completed-with-error status.

Next, the reprint operation in response to reception of a reprint instruction by the image forming apparatus 5 will be described.

First, in response to reception of specification of an error avoidance method and a reprint instruction via the reprint button 67 and the process determination button 75, a print job is started (step S501). In addition, as the print job is started, the error determiner 29 turns “OFF” the error occurrence flag (step S502). In addition, the data processor 21 analyzes the print instruction (step S503), and the error detector 27 determines whether an error has been detected (step S504).

Here, since no error has been excluded in the reprint instruction even after the end of the normal print operation, the error detector 27 detects an error (Yes in step S504). The data processor 21 determines whether the print instruction is a reprint instruction (step S510). Since this case is reprinting (Yes in step S510), next, the data processor 21 determines whether the specified error avoidance method in the reprint instruction is to “print except for an error page (skip an error page)” (step S514).

In the case where the error avoidance method is not to “skip an error page” (No in step S514), the data processor 21 ignores a render command where the error has occurred, and continues analyzing (step S513). In the case where a page or pages to be analyzed ends/end (Yes in step S505) and in the case where the entire print instruction has been analyzed (Yes in step S506), the image formation controller 23 determines whether the error occurrence flag is “ON” (step S507). Here, since the error occurrence flag remains to be in the “OFF” status since step S502 (No in step S507), the image forming unit 17 forms an image on a sheet (step S508). At this time, an image formed on a sheet is formed while ignoring a render command where the error has occurred (see part (C-1) of FIG. 4C).

In contrast, in the case where the error avoidance method is “to skip an error page” (Yes in step S514), the data processor 21 ignores (skips) a render command until the end of a page where the error has occurred (step S515). The data processor 21 determines whether the specified error avoidance method in the reprint instruction sets an error occurrence page to be output as blank (step S516). In the case of not outputting an error occurrence page as blank (No in step S516), the data processor 21 excludes a page where the error has occurred (step S517).

In the case where the entire print instruction has been analyzed (Yes in step S506), the image formation controller 23 determines whether the error occurrence flag is “ON” (step S507). Here, since the error occurrence flag remains to be in the “OFF” status since step S502 (No in step S507), the image forming unit 17 forms an image on a sheet (step S508). At this time, an image formed on a sheet is formed while excluding an error occurrence page (see part (C-2) of FIG. 4C).

In addition, in the case of outputting an error occurrence page as blank (Yes in step S516), the data processor 21 replaces a page where the error has occurred with a blank sheet (step S518). In the case where the entire print instruction is analyzed (Yes in step S506), the image formation controller 23 determines whether the error occurrence flag is “ON” (step S507). Here, since the error occurrence flag remains to be in the “OFF” status since step S502 (No in step S507), the image forming unit 17 forms an image on a sheet (step S508). At this time, an image formed on a sheet is formed while replacing a page where the error has occurred with a blank sheet (see part (C-3) of FIG. 4C).

Although omitted in the above description, for example, in step S510, the error determiner 29 determines the type of the detected error. In the case where the error determiner 29 determines the error type as “critical”, the subsequent process is not continued, and the job for the print instruction is completed with error. Specifically, in the case where the error determiner 29 determines the error type as “critical”, storage of error information of the detected error by the error information retainer 31 (step S511) is not executed. In addition, storage (accumulation) of information regarding the print instruction (job) where the error has occurred by each of the print data accumulator 33 and the job history recorder 35 (step S509) is not executed. In doing so, for example, the storage capacity taken by the print data accumulator 33 and the job history recorder 35 is suppressed.

Note that error types other than “critical” in this example are examples of predetermined types.

### Modifications

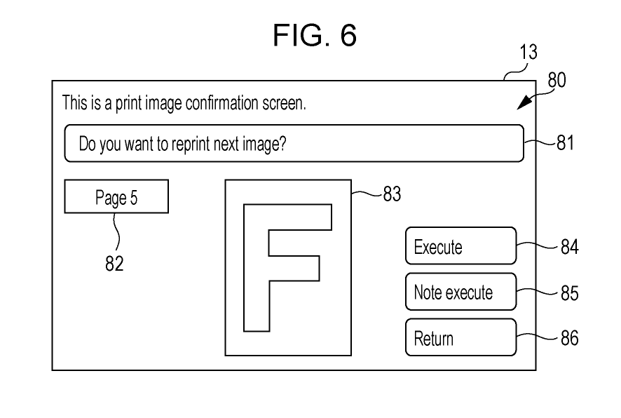

FIG. 6 illustrates an example of another reprint screen 80 in a modification.

Although it has been described in the embodiment that reprinting is executed in response to operation of the process determination button 75 in the above-described exemplary embodiment, the exemplary embodiment is not limited to this case. For example, as illustrated in FIG. 6, after the first button 751 of the process determination button 75 is operated, that is, after “ignore error and print” is selected, this other reprint screen 80 may be displayed.

Here, the other reprint screen 80 includes query information 81 that asks whether to execute reprinting, a page number 82 of a page where an error has occurred in a print instruction, a preview image 83 that is an image formed when printing a page where the error has occurred while ignoring that error, an execute button 84 that accepts an instruction to execute reprinting including a page displayed in the preview image 83, a not-execute button 85 that accepts an instruction not to execute reprinting, and a return button 86 that accepts an instruction to return to the reprint screen 70 (FIG. 3C) without determining execution of reprinting.

As described above, by displaying the other reprint screen 80, whether to execute reprinting is determined after the user sees and understands an image that is formed while ignoring an error.

Although the case in which the first button 751 of the process determination button 75 is operated has been described here, the modification is not limited to this case. For example, the other reprint screen 80 may be displayed after, for example, the third button 753 is operated, that is, “print an error occurrence page as blank” is selected.

In the above description, the print data accumulator (see FIG. 2) which stores a print instruction determined to include an error has been described. The print data accumulator 33 may be configured as a storage area set for each user who gives a print instruction, that is, a so-called confidential box. Re-output may be configured to be performed by selecting a job stored in this confidential box. By storing a job in the confidential box, other users are prevented from giving a re-output instruction.

Note that, in the case where the configuration involves user log-in when using the image forming apparatus 5, for example, the UI controller 25 may have a notification function that notifies a user who logs in whether there is a print job to be reprinted in the user's confidential box. In addition, for example, this notification may be given by displaying an image (such as a dialog or a dedicated icon) on the UI 13 or by causing an illuminating device (such as a light-emitting diode (LED)) to blink.

In addition, the print data accumulator 33 may be configured to be a special queue that stores error-detected data, and a reprint instruction may be configured to be given by selecting a job from a list of jobs where errors have occurred. Further, the print data accumulator 33 may be configured to include multiple storage areas and to switch a storage area in accordance with user information of a user or the presence of the user's confidential box.

Although the case in which an error occurs during the analysis or rasterizing of print data has been described in the above exemplary embodiment, the exemplary embodiment is not limited to this case.

For example, the above exemplary embodiment is applicable to the case of the occurrence of a memory insufficiency error that the memory becomes insufficient during analysis (rendering) of a specific page, for example.

Specifically, in the case where a memory insufficiency error occurs, error avoidance methods that may be provided to the user are as follows: “cancel (discard) job”, “output no error occurrence page”, “output an error occurrence page as blank”, “reduce the image quality mode of an error occurrence page and print”, and “change the color mode of an error occurrence page and print”.

For example, in the case where the image quality mode of a print instruction where an error has occurred is a mode that involves a larger memory, such as a high image quality mode, the error may be avoided by applying “reduce the image quality mode of an error occurrence page and print”. That is, in this example, the image quality mode is changed from a high image quality mode to a standard mode or a low memory mode that involves a smaller memory, and printing is performed again. In doing so, the error may be avoided.

In addition, for example, in the case where the specified color mode in a print instruction where an error has occurred is color, the error may be avoided by applying “change the color mode of an error occurrence page and print” and changing the color mode to a monotone mode or a toner saving mode that involves a small memory.

In another example, the above exemplary embodiment is applicable to the case in which, for example, font data specified in print data is not available in the image forming apparatus 5.

Specifically, error avoidance methods that may be provided to the user are as follows: “cancel (discard) job”, “output no error occurrence page”, “output an error occurrence page as blank”, “select alternative font data”, “perform process by ignoring a corresponding character (blank)”, and “perform process by printing a corresponding character as a specific symbol (missing glyph)”.

For example, in the case where the user wants to execute printing even with another font, the error may be avoided by applying “select alternative font data”.

In addition, in the case where the user wants to first detect the place of an error occurring in that page, the error may be avoided by applying “perform process by ignoring a corresponding character” or “perform process by printing a corresponding character as a specific symbol”.

Although the case in which an error occurs during the analysis or rasterizing of print data has been described in the above exemplary embodiment, the exemplary embodiment is not limited to this case. For example, the above configuration is applicable to the case in which a print instruction does not match a function usable with the image forming apparatus 5, such as when selecting a replacement tray in the case where a sheet specified as a sheet on which printing is performed is unavailable in a sheet feeding portion (tray, not illustrated) or when changing the specification of post-processing (finishing). In particular, in the case where the size or direction of an output sheet is changed, instead of retaining raster data obtained as a result of rendering, print data is accumulated, the setting is changed, and reprinting is performed. Thus, many choices of error avoidance methods, such as rotation, scaling, and color adjustment in rendering, may be provided.

A reprint instruction may be given not only from the job status screen 50 (see FIG. 3A) which performs display on the UI 13 of the image forming apparatus 5, but also from a job history that is remotely browsable, such as the terminal apparatus 3 via the network 7, for example.

In addition, in the case where the terminal apparatus 3 and the image forming apparatus 5 are capable of performing bidirectional communication, the occurrence of an error and error avoidance choices for reprinting may be displayed on the terminal apparatus 3.

In addition, for example, reporting that there is a completed-with-error job that is reprintable may be executed using the UI 13 or an illuminating device (not illustrated).

It has been described in the above exemplary embodiment that the error information retainer 31 stores an error avoidance method in association with an error that has occurred. However, instead of storing an error avoidance method in association with an error that has occurred, when performing display on the UI 13, the UI controller 25 may refer to error avoidance methods stored in advance in the error information retainer 31, and may display an error avoidance method that corresponds to an error that has occurred.

Although it has been described in the above exemplary embodiment that the error information retainer 31 stores an error avoidance method, an error occurrence page, and an error occurrence command place along with an error that has occurred, the configuration may be such that any of an error avoidance method, an error occurrence page, and an error occurrence command place is stored along with an error that has occurred, or, in addition to an error avoidance method, an error occurrence page, and an error occurrence command place, information other than those described above is stored along with an error that has occurred.

For example, the configuration may be such that error information determined by the error determiner 29 is sent via mail or the like to a client who has given a print instruction, a server that manages a log, or a manufacturer support. By sending the error information, the error information may be referred to when the administrator or the manufacturer handles a problem of the error.

Print data and error information linked with a job history are deleted at a timing at which the print data and the error information disappear (pushed out) from a display of the job history in the case where subsequent jobs, the number of which is greater than a predetermined number, are input, or may be erased after a predetermined time elapses.

In addition, regarding a reprintable job, a normal job subsequent to that error occurrence job is first deleted from a job history, thereby allowing the error occurrence job to remain (not to disappear) in the job history. In doing so, even when there are a great number of jobs, an error occurrence job becomes reprintable.

Although various exemplary embodiments and modifications have been described above, needless to say, the configuration may be one that combines these exemplary embodiments and modifications.

In addition, the present disclosure is not limited to the above exemplary embodiment, and various embodiments are possible without departing from the gist of the present disclosure.

What is claimed is:

1. An image forming apparatus comprising:
an image forming unit that receives a print instruction including print data and a print setting and forms an image on a sheet;
a detector that analyzes at least one of the print data and the print setting in the print instruction received by the image forming unit, and detects an error that is an instruction unprocessable by the image forming apparatus or an instruction invalid for the image forming apparatus to process;
an avoidance process memory that stores, in a case where the error is detected by the detector, an error avoidance process of avoiding the error and enabling execution of image formation, in association with the print instruction including the error;
a print data memory that stores, in a case where the error is detected by the detector, the print data in the print instruction including the error; and
an acceptor that accepts an instruction to avoid the error and to execute image formation, in accordance with the error avoidance process stored in the avoidance process memory and the print data stored in the print data memory.

2. The image forming apparatus according to claim 1, wherein, as the print data in the print instruction including the error is stored in the print data memory, the image forming unit becomes capable of performing image formation in accordance with a print instruction subsequent to the print instruction including the error before performing image formation in accordance with the print instruction including the error.

3. The image forming apparatus according to claim 1,
wherein, in a case where a type of the error is a predetermined type, the avoidance process memory stores the error avoidance process in association with the print instruction including the error, and
wherein, in a case where the type of the error is determined to be the predetermined type, the print data memory stores the print data in the print instruction including the error.

4. The image forming apparatus according to claim 1, further comprising a formed image display that displays an image formed on a page including the error in the print instruction by executing image formation at a time at which the acceptor accepts an instruction to avoid the error and to execute image formation.

5. The image forming apparatus according to claim 1,
wherein the print data memory stores the print data in the print instruction including the error, the print data having been analyzed by the detector, and
wherein, in response to acceptance by the acceptor of an instruction to avoid the error and to execute image formation, the image forming unit executes image formation in accordance with the print data analyzed by the detector and stored in the print data memory.

6. The image forming apparatus according to claim 5, further comprising a replacing unit that replaces a page where the error has occurred, out of the print data analyzed by the detector and stored in the print data memory, with a predetermined page,
wherein, in response to acceptance by the acceptor of an instruction to avoid the error and to execute image formation, the image forming unit executes image formation in accordance with the print data in which the page where the error has occurred is replaced by the replacing unit.

7. An image forming apparatus comprising:
an error display that displays, among print instructions received by an image forming unit that forms an image on a sheet, a print instruction that is an instruction unprocessable by the image forming apparatus or an instruction invalid for the image forming apparatus to process;
a process display that displays a type of an error avoidance process of avoiding the error included in the print instruction and enabling execution of image formation; and
an instruction acceptor that accepts an instruction to execute image formation in accordance with the print instruction while applying the error avoidance process displayed on the process display.

8. The image forming apparatus according to claim 7, further comprising a history display that displays a history of the print instruction received by the image forming unit,
wherein the instruction acceptor is displayed after selecting a print instruction including the error displayed as part of the history on the history display.

9. An image forming method comprising:
receiving a print instruction including print data and a print setting and forms an image on a sheet;
analyzing at least one of the print data and the print setting in the received print instruction, and detecting an error that is an instruction unprocessable by an image forming apparatus or an instruction invalid for the image forming apparatus to process;
storing, in a case where the error is detected, an error avoidance process of avoiding the error and enabling execution of image formation, in association with the print instruction including the error;
storing, in a case where the error is detected, the print data in the print instruction including the error; and
accepting an instruction to avoid the error and to execute image formation, in accordance with the stored error avoidance process stored and the stored print data, in response to an operation performed by a user.
